(19) United States
(12) Patent Application Publication
(10) Pub. No.: US 2005/0161305 A1
(43) Pub. Date: Jul. 28, 2005

(54) Electric power tool

(76) Inventors: David Jenni, Winterthur (CH); Remo Frei, Zizers (CH); Curdegn Bandli, Donat (CH)

Correspondence Address: STRIKER, STRIKER & STENBY, 103 EAST NECK ROAD, HUNTINGTON, NY, 11743, US

(21) Appl. No.: 11/028,905

(22) Filed: Jan. 4, 2005

(30) Foreign Application Priority Data
Jan. 10, 2004 (DE) 102004001550.3

(51) Int. Cl. H02P 11/00; F16D 67/00; H02P 9/00; H02H 7/06

(52) U.S. Cl. 192/223; 322/17

(57) ABSTRACT

An electric power tool (10) has at least one battery-powered electric motor, and the electric motor and the battery can be placed on the back of a user by means of a wearable unit (50). Via a flexible shaft (30), a driven tool (40) is driven by the electric motor. The wearable unit (50) has guide means (63 through 65), which engage the flexible shaft (30) in such a way that beginning at the back region of the user (52), this shaft is fixed in the shoulder region in such a way that it is secured against slipping off. This assures good guidance of the flexible shaft (30) and enables the user (52) to work ergonomically (FIG. 1).

### BACKGROUND OF THE INVENTION

The invention is based on an electric power tool as generically defined by the preamble to claim 1.

In a known electric power tool of this kind (German Utility Model DE 299 03 963 U1), a frame to be worn on the user's back is provided, which is held on the body of the user by means of supporting belts; the frame is intended to rest on the user's back. In the frame, an electric drive motor on the one hand and detached from it a battery pack are provided. The frame also includes a control unit for controlling the electric motor and the drawing of energy and so forth. The electric motor is located at the very bottom in the frame. The electric shaft extends laterally away from it, and on the free end of the shaft a driven tool is attached, in the form of pruning shears. The flexible shaft is extended along the user's side and under his arms to the front. This is an extreme hindrance and is problematic in use. Another disadvantage is the frame that can be worn on the back, which in this design is large, heavy, and cumbersome to handle.

### SUMMARY OF THE INVENTION

The electric power tool of the invention, as defined by the characteristics of claim 1, has the advantage over the prior art that the flexible shaft is extended over the user's shoulder and is fixed in this region in a way that secures it against slipping off. The result is a favorable course of the flexible shaft, which beginning for instance at the back extends approximately vertically upward, then over one of the two shoulders of the user, and from there either in a straight line or approximately diagonally to the front over the user's chest. The flexible shaft has a uniform curved course, resulting in less wear and a long service life of the flexible shaft. The power tool makes it possible to work economically with individual driven tools that can be connected to the flexible shaft.

By the provisions recited in the further claims, advantageous refinements of and improvements to the electric power tool defined by claim 1 are possible.

It may moreover be advantageous here if the electric motor and at least one battery fitting it are combined in a drive unit that can be worn on the back and is accommodated interchangeably in the wearable unit. The drive unit may have two or more batteries combined with the electric motor, which are joined detachably to the drive unit and may be embodied as spare batteries. It may also be advantageous if the drive unit contains a control unit integrated with it for controlling the electric motor in particular, or the drawing of energy or the like. It may furthermore be advantageous if the drive unit has one spare holder for each battery. At least two existing batteries can advantageously be located in the drive unit and/or controlled in such a way that in operation of a driven tool connected to it, either parallel or sequential discharging takes place. In an advantageous refinement of the power tool, it has at least one additional electrical connection, in particular an electrical socket, to which a further electrical consumer can be connected. This at least one additional connection may be located on the drive unit or is for instance located instead on the wearable unit, preferably in its front region, and connected to the drive unit via a connection cable. It can also be advantageous if the electric motor is contained in the drive unit in a way accessible to maintenance, in particular if it has a cap that can be removed for servicing. It can furthermore be especially advantageous if the flexible shaft is detachably coupleable to the drive unit and/or to a driven tool by means of a fast-action coupling. Advantageously, the flexible shaft can be combined with at least one control line that connects a connected driven tool to the drive unit; this at least one control line can be integrated with the flexible shaft, and its connections are also integrated with the fast-action couplings of the flexible shaft.

### BRIEF DESCRIPTION OF THE DRAWINGS

The invention is described in further detail in terms of an exemplary embodiment shown in the drawings. Shown are:

FIG. 1, a schematic perspective view of an electric power tool held by means of a wearable unit;

FIG. 2, a schematic perspective view of the drive unit of the power tool in FIG. 1;

FIG. 3, a schematic perspective view of a driven tool of the power tool in FIG. 1;

FIGS. 4 and 5, each, a schematic perspective view, in further detail, of the drive unit in FIG. 1, which is visible from behind in FIG. 4 and from the front in FIG. 5.

### DESCRIPTION OF THE PREFERRED EMBODIMENTS

In the drawings, an electric power tool 10 is schematically shown which has a drive unit 20, a flexible shaft 30, and a virtually arbitrary driven tool 40, which can for instance be a screwdriver, hammer, saw, grinder, power drill, pruning shears, or the like and is connectable in a way to be driven to rotate to one end of the flexible shaft 30. In the exemplary embodiment shown, a screwdriver is provided for example as the driven tool 40, which as shown in FIG. 1 is connected to the flexible shaft 30. The drive unit 20 contains an electric motor 11, which is not further visible and which depending on the design has a gear downstream of it and can be powered by at least one battery that fits it, which in the exemplary embodiment shown are two batteries 21, 22 which are rechargeable. The electric motor, not visible, and at least one battery 21, 22 that fits it are combined in the drive unit 20 into a unit for use, to which the flexible shaft 30 is connected by the other end, diametrically opposite the driven tool 40. The power tool 10 can be placed securely on the schematically indicated back 51 of a user 52 by means of a schematically indicated wearable unit 50.

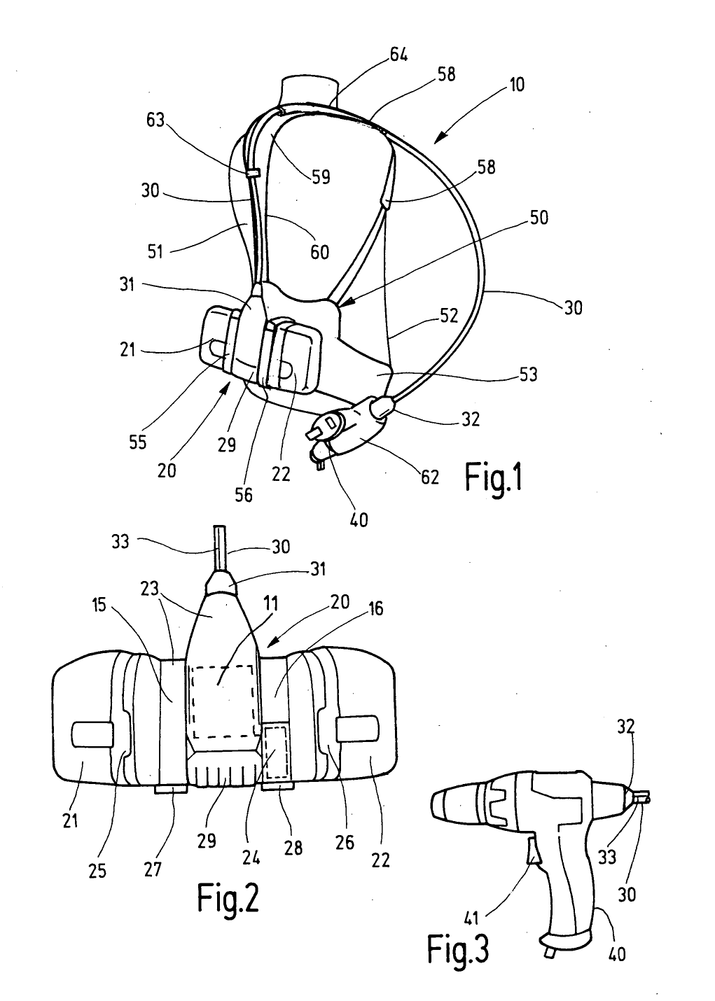

In the exemplary embodiment shown, the drive unit 20 has two batteries 21, 22, which are detachably connected to the drive unit 20 and are embodied as spare batteries of conventional design. In a modified exemplary embodiment, it is also possible instead for only a single battery, or more than two batteries, to be provided. The electric motor not further shown is located inside a housing 23 of the drive unit 20, on which the batteries 21 and 22 are mounted, one on each side, in alternation. The drive unit 20, inside the housing 23, furthermore contains at least one control unit 24 integrated with it, which is merely indicated by dashed lines in FIG. 2. The control unit 24 serves to control the electric motor, for instance, of the drive unit 20 and the drawing of energy. The drive unit 20 has one spare holder 25, 26, schematically indicated, for each battery 21, 22. The at least two batteries 21, 22 are located and/or controlled inside the drive unit 20 in such a way that when the driven tool 40 is switched on, either parallel or sequential discharging of the batteries 21, 22 is possible.

The power tool 10 furthermore has at least one additional electrical connection, to which a further, external electrical consumer can be connected. In the exemplary embodiment shown, two such additional electrical connections 27 and 28 are indicated, located on the drive unit 20. These connections 27 for instance each comprise an electrical socket, for instance in the form of a cigarette lighter socket. In another exemplary embodiment, not shown, the at least one additional connection 27, 28 is located instead on the wearable unit 50, preferably in the front region of it, and is joined to the drive unit 20 via a connection cable, which extends from the front side of the wearable unit 50 its back side, where the drive unit 20 is accommodated interchangeably in the wearable unit 50.

The electric motor, not shown on its own, contained in the drive unit 20 is accommodated therein in a way accessible to maintenance. It may be advantageous if for that purpose the drive unit 20 for instance has a cap 29, shown only schematically, that can be removed for servicing or the like.

The flexible shaft 30 can be detachably coupled by means of an only schematically indicated fast-action coupling 31 on one end and 32 on the other end to the drive unit 20 and a driven tool 40, respectively. The driven tool 40 has a switch 41 for switching the drive, effected via the flexible shaft 30, on and off. The switch is in communication with a control line 33, which in particular is electrical, and which begins at the drive unit 20, and in particular at its control unit 24. The flexible shaft 30 may be combined with at least one such control line 33. It is especially advantageous if the at least one control line 33 is integrated with the flexible shaft 30, and its connections are integrated with the fast-action couplings 31, 32 of the flexible shaft 30. An electrical control line of this kind inside the flexible shaft 30 is merely indicated in FIGS. 2 and 3.

The wearable unit 50 has a hip belt 53, which in terms of its circumference is adjustable and which is padded. On the side toward the back 51 of the user 52, the hip belt 53 is provided with a holder, identified in general by reference numeral 54, which is located above the hip of the user 51 and serves the purpose of interchangeably holding the drive unit 20. The holder 54, in the exemplary embodiment shown, advantageously comprises loops 55 and 56, which are for instance detachable and can be fixed by means of adhesive closures and which can for instance be guided in an associated groove 15, 16 of the drive unit 20, while on the outside, in the region of the respective grooves 15 and 16, they fit over the drive unit 20 and fix the hip belt 53 on the back.

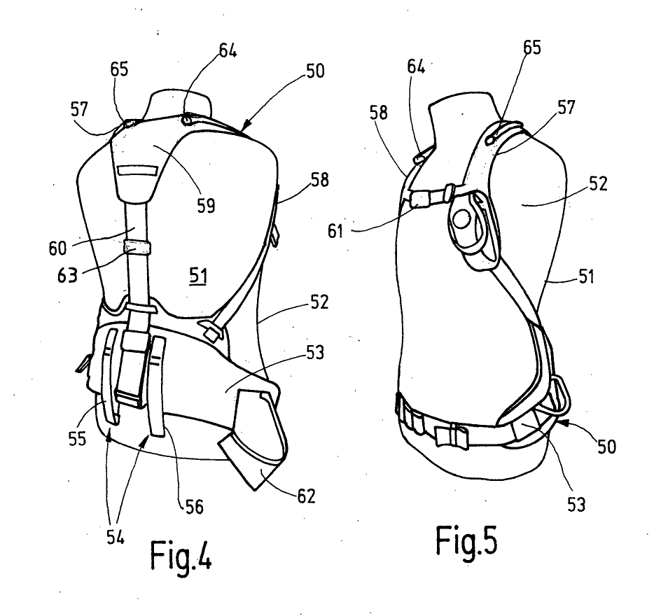

The wearable unit 50 furthermore has two shoulder belts 57 and 58, which lead to the hip belt 53 and may likewise be padded and adjustable. In the rear region, associated with the back 51 of the user 52, the shoulder belts 57, 58 are united approximately in the shoulder region 59 and are joined there to a back belt 60, which leads to the hip belt 53. The hip belt 53 is designed approximately conically, viewed in the vertical direction, in adaptation to the hip contour of a user 52 and is thus adapted anatomically. The back belt 60 may likewise be padded and adjustable. On the side associated with the chest of the user 52, the two shoulder belts 57, 58 may be joined together by means of a chest belt 61 extending crosswise, which may likewise be padded and adjustable. As can be seen from FIGS. 1 and 4, the hip belt 53, on at least one side, has an approximately pocketlike holster 62 for a driven tool 40. The wearable unit 50 configured in this way has a certain similarity to a backpack and can be adjusted optimally to various body sizes and shapes by adjustment of the individual belts, in particular the hip belt 53, the shoulder belts 57, 58, the back belt 60, and the chest belt 61. The design of the hip belt 53 and its rear holder 54 for the drive unit 20 assures that the drive unit is seated above the hip of the user 52 and thus anatomically correctly, without putting any particular additional loads on the body.

A further special feature of the wearable unit 50 is that it has guide means, indicated schematically by reference numerals 63, 64 and 65, which engage the flexible shaft 30 in such a way that beginning in the region of the back of the user 52, this shaft is fixed in a way secure against slipping, at least in the user's shoulder region. These guide means 63 through 65 engage the flexible shaft 30 in such a way that the shaft is carried forward over the back 51 and—as the user 52 chooses—over one of the two shoulders and from there in a straight line or diagonally forward over the chest of the user 52. Each shoulder belt 57, 58 has, as guide means 64, 65 in the shoulder region, a guide extending along this region, in particular in the form of a tubular sleeve, through which the flexible shaft 30 is passed. This guidance of the flexible shaft 30 assures that it is guided forward and from below, beginning approximately vertically upward, over the back 51 and over the shoulder of the user 52, and the flexible shaft 30 is prevented from slipping off the shoulder, for instance, in the process. In the rear region of the wearable unit 50, the back belt 60 there has, as a guide means 63, a guide extending along the back belt 60, in particular in the form of a loop or a tubular sleeve that accommodates the flexible shaft 30. This assures that the flexible shaft 30, in the region of the back 51 of the user 52, is guided securely upward to the shoulder and cannot shift laterally. The guide means 63 through 65 described can be attached detachably to the wearable unit 50, for instance by means of adhesive closures on the order of hook and loop closures or the like. Instead, these guide means 63 through 65 may comprise parts of the kind that are opened and closed and kept in the closed position by means of adhesive closures. Because of the described guidance and holding of the flexible shaft 30 on the wearable unit 50, it is attained that the user 52 is not hindered by the flexible shaft 30 whenever the driven tool 40 is not in use, and as shown in FIG. 1, the tool has been put away by being inserted into the holster 62 on the hip belt 53. In terms of the guidance of the flexible shaft 30 over one of the shoulders, the user 52 can choose whether the guidance is over the left shoulder via the guide means 65 on that side, or the right shoulder, via the guide means 64 on that side. Because of this guidance of the flexible shaft 30, it is possible to work economically using whatever driven tools 40 are attached, which are driven via the shaft 30 by the drive unit 20 placed on the back of the user 52. Because the power tool 10 is divided into a drive unit 20 and a driven tool 40, which are joined to one another by the flexible shaft 30, manifold advantages are obtained. Because of the external placement of the power supply and the expansion of its capacity, the tool part formed by the driven tool 40 becomes markedly lighter, more compact, and handier. Because of the special design, the drive unit 20 is small, light, and easily replaced. It can be optimally worn above the hip on the back of the user 52. Because of the at least one additional external connection 27, 28, still other external users can be operated as well.

1. An electric power tool, having at least one battery-powered electric motor (11), which can be placed on the back (51) of a user (52) by means of a wearable unit (50) and by means of which, via a flexible shaft (30), a driven tool (40), such as a screwdriver, hammer, grinder, power drill, saw or the like, can be driven, characterized in that the wearable unit (50) has guide means (63 through 65), which engage the flexible shaft (30) in such a way that beginning in the region of the back of the user (52), this shaft is fixed in the shoulder region in such a way that it is secure against slipping off.

2. The electric power tool of claim 1, characterized in that the guide means (63 through 65) engage the flexible shaft (30) in such a way that this shaft is directed over the back (51) and one of the two shoulders of the user (52) and from there toward the front in a straight line or approximately diagonally over the user's chest.

3. The electric power tool of claim 1, characterized in that the wearable unit (50) has a hip belt (53) and on it, on the side toward the back (51) of the user (52), a holder (54), located above the hip of the user (52), for instance in the form of detachable loops (55, 56), belts, or the like that are fixable by means of adhesive closures, for interchangeably holding a drive unit (20), which contains the electric motor and at least one battery (21, 22) combined with it.

4. The electric power tool of claim 3, characterized in that the wearable unit (50) has two shoulder belts (57, 58), leading to the hip belt (53), which in the region (59) associated with the back (51) of the user (52) are united and joined to a back belt (60) leading to the hip belt (53).

5. The electric power tool of claim 1, characterized in that at least one of the shoulder belts (57, 58), or both, in the shoulder region has a guide (64, 65) extending along this region, in particular a tubular sleeve accommodating the flexible shaft (30).

6. The electric power tool of claim 1, characterized in that the back belt (60) has a guide (63) extending along it, in particular a loop or a tubular sleeve accommodating the flexible shaft (30).

7. The electric power tool of claim 1, characterized in that the guide means (63 through 65), in particular the guides, are detachably attachable to the wearable unit (50), for instance with adhesive closures or the like, or can be opened or closed, for instance by means of adhesive closures or the like.

8. The electric power tool of claim 3, characterized in that the hip belt (53), viewed in the vertical direction, is designed approximately conically in adaptation to the contour of the hip of a user.

9. The electric power tool of claim 3, characterized in that the hip belt (53), on at least one side, has an approximately pocketlike holster (62) for a driven tool (40).

10. The electric power tool of claim 4, characterized in that the two shoulder belts (57, 58), on the side associated with the chest of the user (52), are joined together by means of a transversely extending chest belt (61).

11. The electric power tool of claim 3, characterized in that the hip belt (53) and/or the shoulder belts (57, 58) and/or the back belt (60) and/or the chest belt (61) are padded and/or adjustable.
